(19) United States
(12) Patent Application Publication
(10) Pub. No.: US 2009/0151170 A1
(43) Pub. Date: Jun. 18, 2009

(54) MULTI-FUNCTION HAND OPERATED PRUNING CLIPPERS

(75) Inventors: Hyok Lee, Corona, CA (US); Michael Williams, San Marcos, CA (US); Thomas Gaboury, El Cajon, CA (US); Philip Curtis Rogers, Temecula, CA (US); Nghiem Tran, Corona, CA (US); Stephen James Hull, Chandler, CA (US)

Correspondence Address: SNELL & WILMER LLP (OC), 600 ANTON BOULEVARD, SUITE 1400, COSTA MESA, CA, 92626, US

(73) Assignee: Corona Clipper, Inc., Corona, CA (US)

(21) Appl. No.: 11/959,180

(22) Filed: Dec. 18, 2007

(51) Int. Cl. B26B 13/00; B26B 13/12; B26B 9/00; B26B 13/22

(52) U.S. Cl. 30/252; 30/271; 30/351; 30/341

(57) ABSTRACT

A hand-operated pruning clipper having a multi-function plastic top handle and metal bottom handle with metal bypass cutting blades for cutting twigs and branches. A pair of wire cutting blades and a plastic bag slicing blade are incorporated into the metal cutting blades.

### BACKGROUND OF THE INVENTION

1. Field of the Invention

The present invention relates generally to improvements in hand operated pruning clippers and more particularly, it pertains to new and improved multi-function pruning clippers.

2. Description of Related Art

Those concerned with the development of pruning clippers for commercial use have long recognized the need for a durable, yet relatively inexpensive hand operated clipper. It has been the practice to employ metal parts for such clippers in order to provide durability. The cost of casting the parts out of metal, however, drives up the price. These clippers have been designed as a mono-functional tool, to clip small branches and twigs.

The present invention on the other hand, provides a hand operated pruning clipper that is both durable and relatively inexpensive to manufacture compared to the prior art clipper, while at the same time providing functions beyond the clipping of twigs and small branches.

### SUMMARY OF THE INVENTION

The general purpose of this invention is to provide a multi-function hand operated pruning clipper which has the durability of an all metal hand clipper without the concomitant cost and provides wire cutter and bag slitting functions. To obtain these advantages the present invention utilizes a top handle having a housing at one end, with a bottom blade having an aperture at one end and a tang extending from the blade, the tang being located in the top handle with the aperture end of the blade in the housing of the top handle. A bottom handle having a bearing at one end adapted for rotating about a shaft has a top blade fixedly attached at the bearing end of the handle. The bearing and a portion of the top blade are located in the housing of the top handle. A bearing shaft extends through the housing of the top handle, through the bearing on the top blade and the aperture of the bottom blade, and is fastened to the housing for containing a portion of the top and bottom blades therein.

A wire cutting function is provided by a wire cutter blade located at the aperture end of the bottom blade and a wire cutter blade located at the bearing end of the top blade. When the top and bottom handles are moved, the wire cutter blades interact.

A bag slitting function is provided by a bag slitting knife edge located on the top blade at the point of the blade. The point of the top blade inserts into the bag to engage the bag slitting edge and cut the bag to the length desired.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a perspective view of a preferred embodiment of the invention;

FIG. 2 is a side view of the embodiment of FIG. 1 in partial section;

FIG. 3 is a perspective view of the preferred embodiment of FIG. 1, showing how it is used to clip wire;

FIG. 4 is a perspective view of the embodiment of FIG. 1 showing how it is used to slit a bag; and

FIG. 5 is an assembly drawing of the preferred embodiment of FIG. 1 showing its various parts.

### DETAILED DESCRIPTION OF THE PREFERRED EMBODIMENTS

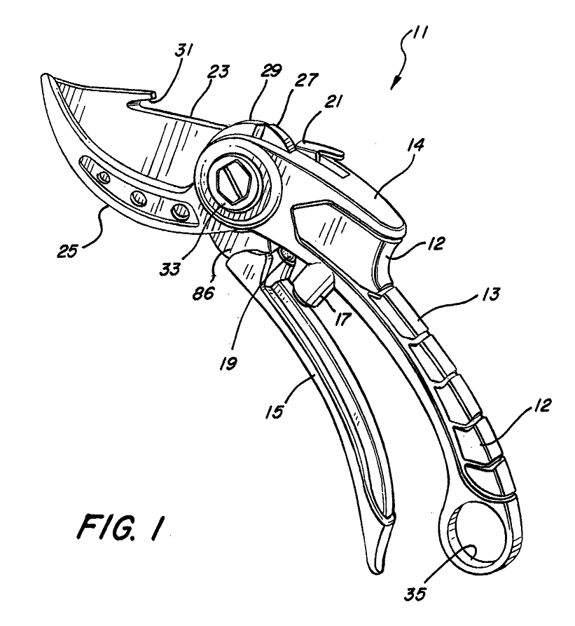

FIG. 1 illustrates a preferred embodiment of the present invention and specifically the major components of the pruning clipper 11. The top handle 13 having a housing 14 at one end and a convenience aperture 35 at the other end is preferably made of molded plastic such as polystyrene or polybutylene, or equivalent. The top portion of top handle 13 has a comfort cushion 12 for cushioning of the palm of the hand when it grasps the tool of the hand operated pruning clipper 11. A bottom blade 25 is fixedly attached to the top handle 13. The bottom blade 25 is formed to also have a wire cutter blade 29.

A bottom handle 15 made out of a preformed or die cast metal such as aluminum, for example, has a handle bearing 86 formed in the end and enclosed within the housing 14 of the top handle 13. A shock absorbing bumper 19 is located in the bottom handle 15 next to the handle bearing. A top blade 23 is attached to the handle bearing 86. The top blade 23 has a wire cutting blade 27 located thereon for engagement with wire cutting blade 29 of the bottom blade 25. Top blade 23 also has a bag slitting edge 31.

The top handle 13 and bottom handle 15 are urged apart by a compression spring arrangement 17 located between the two handles.

Both the top blade 23 and bottom blade 25 as well as the wire cutting blades 29 and 27, are partially located within the housing 14 of top handle 13. These parts are held together in the housing 14 by a shaft having a flat head on one side and a threadable bolt 33 on the other side of the housing 14.

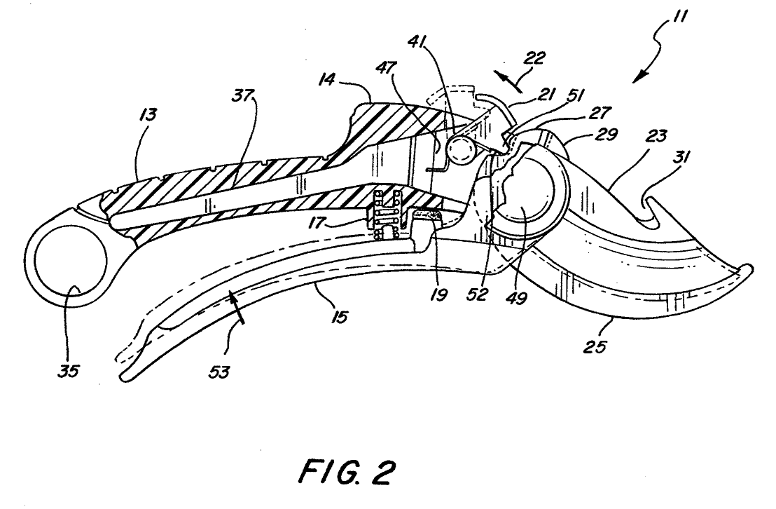

The bottom blade 25 is also held fast to the upper handle 15 by a tang 37 (FIG. 2) extending from lower blade 25 being fixedly located within the upper handle 13.

FIG. 2 also shows the flat head 49 of the shaft that is held in place by the nut and 33 (FIG. 1) on the other end. The compression spring 17 and cushion bumper 19 react to the top handle 13 and bottom handle 15 being squeezed together by a force 53 generated by a human hand (not shown).

A blade locking mechanism 21 having a wedge 51 attached for engaging a complementing recess 52 in the top blade 23 just below the wire cutting blade 27, is pivotally mounted to the bottom blade 25. The locking mechanism 21 pivots about shaft 41 and is biased by a spring 47 in a direction 22, away from the recess 52 in the top blade.

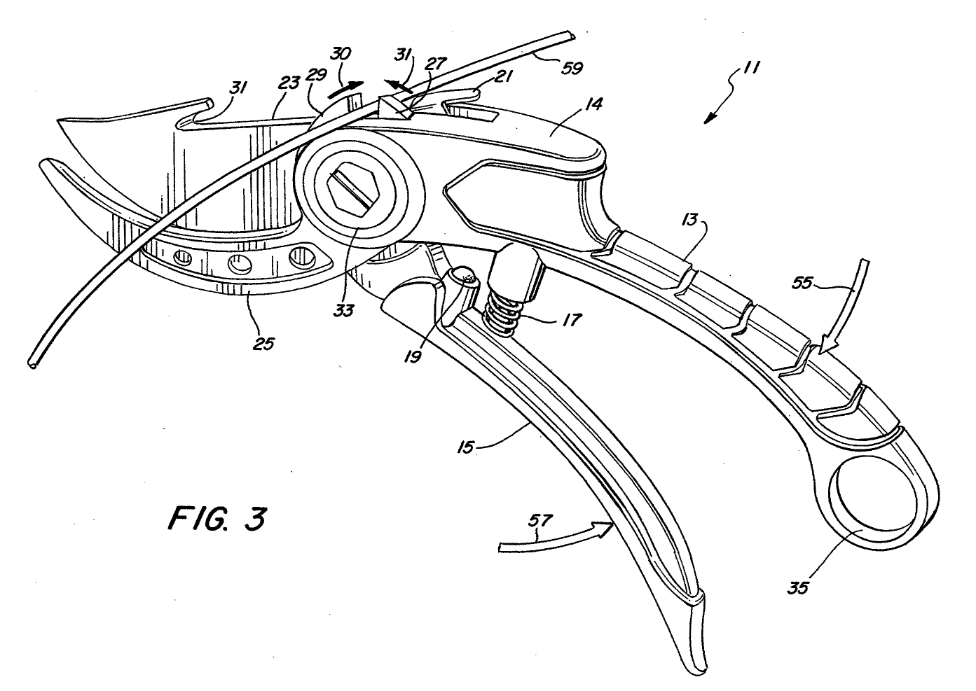

FIG. 3 illustrates the operation of the pruning clippers 11 when cutting the length of a wire 59 by wire cutting blades 29, 27. Applying forces 55 and 57 to the top handles 13 and 15, respectively, causes the wire cutting blades 29 and 27 to move in a direction 31 to close upon and pinch wire 59 into two pieces.

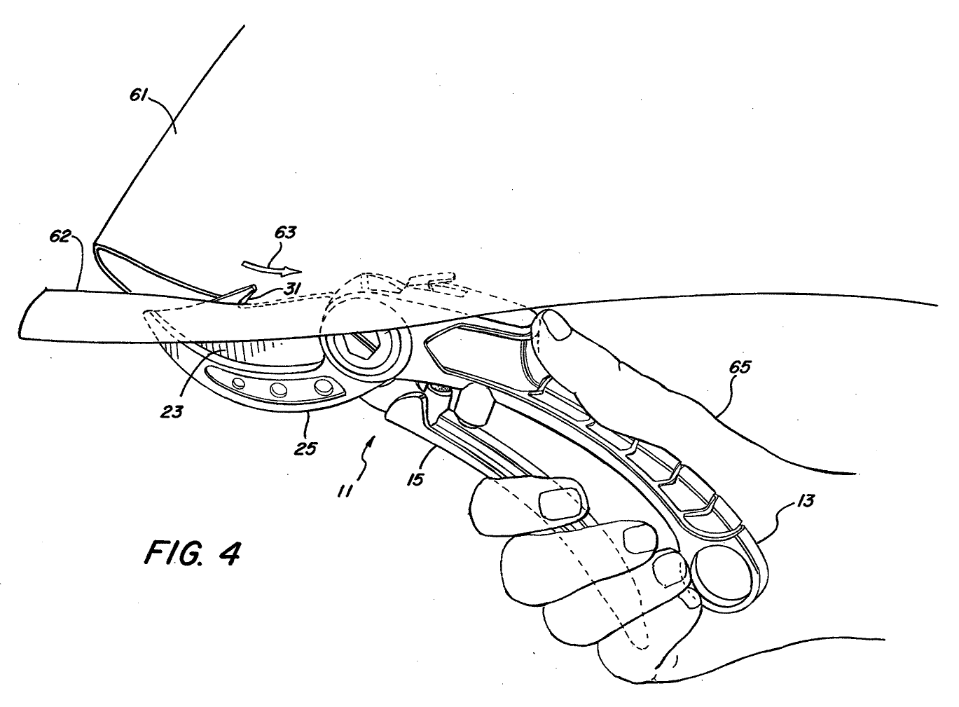

To utilize the bag slitting edge 31 of the pruning clipper 11, the pruning clipper 11 is held in a hand 65 as shown in FIG. 4 with the bag slitting edge 31 engaging a plastic bag 61. Simply moving the clipper 11 in a direction 63 will cut a length 62 of the bag 61, as illustrated.

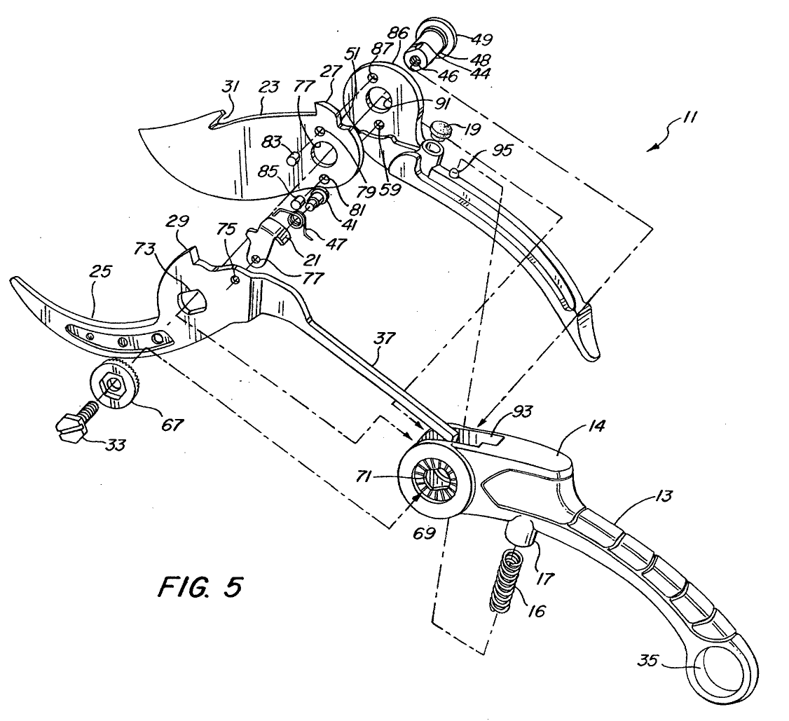

FIG. 5 is an assembly drawing showing the operative parts of the pruning clipper 11 of the present invention and how they fit together.

Bottom blade 25 is formed within an oblong aperture 73 located at one end of blade 25 with a tang 37 extending from the aperture end of blade 25. Blade 25 also has a wire cutting blade 29 located above the oblong aperture 73. A dowel hole 75 in lower blade 25 locates the blade locking lever 21 which has a pivot hole 71 located therein. A pivot shaft 41 extends through the pivot hole 71 into the dowel hole 75. A spring 47 rotates about the pivot shaft 41 to move locking lever 21 in a direction away from the complementary locking recess 52 located in top blade 23. Bottom blade 25 is held fast by top handle 13 as the result of tang 37 being located within handle 13. The oblong aperture 73 of blade 25 is aligned with the oblong aperture 71 in one side of the housing 14 of top handle 13. Bottom blade 25 is held against the left inner edge of the slot 93 formed in housing 14 of top handle 13.

Bottom handle 15 is formed to include a bearing 86 at one end which has a circular aperture 91. The top blade 23 is pinned to bearing 86 by a pair of dowels 83, 85 through dowel holes 79, 81. Top blade 23 has a circular aperture 77 that aligns with the circular aperture 91 in the bearing 86. Top blade 23 is held against the right inner edge of slot 93 of housing 14 by a shaft 48, about which upper blade 23 rotates.

Shaft 48 has a flattened head 49 at one end and a threaded aperture 46 at the other end. The threaded aperture end 46 of shaft 48 has flattened surfaces 44 thereon which mate with the elongated aperture 73 of lower blade 25 and the elongated aperture 71 in one side of housing 14 of the bottom handle 13. Shaft 48, therefore, allows the top blade 23 to rotate about its circumference but maintains the bottom blade 25 stationary with the top handle 13.

The threaded aperture 46 of shaft 48 receives a bolt 33 which passes through a washer 67 that engages locking ribs 69 on the side of housing 14 of top handle 13 to hold both blade structures within the slot 93 of housing 14 on top handle 13.

A cushion bumper 19 is located on the bottom handle 15 adjacent to the bearing 86 so that squeezing the handles together will cause cushion bumper 19 to contact the lower surface of the top handle 13. A compression spring 16 is contained between a boss 95 on bottom handle 15 and boss 17 on top handle 13, causing the handles to be forced apart, if the locking lever 21 is not engaged.

Thus, the present invention provides a multi-function hand operated pruning clipper that is extremely durable yet inexpensive to manufacture.

What is claimed is:

1. Hand-operated pruning clippers comprising:
a top handle having a housing at one end;
a bottom blade having an aperture at one end and a tang extending from the blade at the aperture end, the tang located in the top handle, with the aperture end of the blade in the hosing of the top handle;
a bottom handle having a bearing with an aperture at one end;
a top blade fixedly attached to the bearing of the bottom handle, the bearing and a portion of the top blade located in the housing of the top handle; and
a shaft extending through the housing of the top handle, the aperture in the bearing on the top blade and the aperture of the bottom blade, the shaft being fastened to the housing, for containing the top and bottom blades therein.

2. The hand-operated pruning clipper of claim 1 wherein:
the bottom blade has a wire cutter blade located at the aperture end; and
the top blade has a wire cutter blade located at the bearing end.

3. The hand-operated pruning clippers of claim 1 wherein the top blade has a bag slitting edge located on the blade at the end opposite to the end attached to the bearing of the bottom handle.

4. The hand-operated pruning clippers of claim 1 further comprising a blade locking mechanism having a lever pivotally attached to the lower blade in the housing, the lever having a wedge for engaging a recess in the top blade.

5. The hand-operated pruning clippers of claim 1 further comprising a shock absorbing bumper on the bottom handle for engaging the top handle when the top and bottom handles are squeezed together.

6. The hand-operated pruning clippers of claim 5 further comprising a compression spring connected between the top and bottom handles, near the shock absorbing bumper.

7. The hand-operated pruning clippers of claim 1 wherein the aperture in the bottom blade is oblong and the shaft extending through the housing of the top handle has an oblong end that mates with the oblong aperture of the bottom blade, thereby preventing rotation of the bottom blade about the shaft.

8. The hand-operated pruning clippers of claim 1 wherein the top handle and housing are formed of plastic.

9. The hand-operated pruning clippers of claim 1 wherein the bottom handle and bearing are formed of metal.

10. The hand-operated pruning clippers of claim 8 wherein the top handle has a cushioned insert along its length where a hand is normally placed.

11. The hand-operated pruning clippers of claim 2 wherein the top blade has a bag slitting edge located at the end opposite to the end attached to the bearing of the bottom handle.

12. The hand-operated pruning clippers of claim 11 further comprising a blade locking mechanism having a lever pivotally attached to the lower blade portion in the housing, the lever having a wedge for engaging a complementary recess in the top blade.

13. The hand-operated pruning clippers of claim 12 further comprising a shock absorbing bumper on the bottom handle for engaging the top handle when the top and bottom handles are squeezed together.

14. The hand-operated pruning clippers of claim 13 wherein the aperture in the bottom blade is oblong and the shaft extending through the housing of the top handle has an oblong end that mates with the oblong aperture of the bottom blade, thereby preventing rotation of the bottom blade.

15. The hand-operated pruning clippers of claim 13 further comprising a compression spring connected between the top and bottom handles near the shock absorbing bumper.

16. The hand-operated pruning clippers of claim 15 wherein the aperture in the bottom blade is oblong and the shaft extending through the housing of the top handle has an oblong end that mates with the oblong aperture of the bottom blade thereby preventing rotation of the bottom blade.

17. The hand-operated pruning clippers of claim 15 wherein the top handle and housing are formed of plastic.

18. The hand-operated pruning clipper of claim 17 wherein the top handle has a cushioned insert along the length where a hand is normally placed.

19. The hand-operated pruning clippers of claim 16 wherein the top handle and housing are formed of plastic.

20. The hand-operated pruning clippers of claim 19 wherein the top handle has a cushioned insert along its length where a hand is normally placed.
